(19) United States
(12) Patent Application Publication
(10) Pub. No.: US 2013/0009917 A1
(43) Pub. Date: Jan. 10, 2013

(54) Source Driver Array and Driving Method, Timing Controller and Timing Controlling Method, and LCD Driving Device

(76) Inventor: Chin-Hung Hsu, Taoyuan County (TW)

(21) Appl. No.: 13/272,240

(22) Filed: Oct. 13, 2011

(30) Foreign Application Priority Data
Jul. 7, 2011 (TW) 100124022

(51) Int. Cl. G09G 3/36; G06F 3/038

(52) U.S. Cl. 345/204; 345/87

(57) ABSTRACT

A driving method for a source driver array is disclosed. The source driver array includes a leading source driver and at least one cascade source driver. The driving method includes utilizing a latch data signal and a reset section of a frame signal to control the leading source driver and the at least one cascade source driver to enter a stand-by state, respectively, and trigger the leading source driver to receive the corresponding data of the frame signal, and utilizing a polarity control signal to sequentially trigger the at least one cascade source driver to receive the corresponding data of the frame signal in different times, and further utilizing the polarity control signal to control the signal polarities of a plurality of source driving signals of the leading source driver and the at least one cascade source driver.

### BACKGROUND OF THE INVENTION

1. Field of the Invention

The present invention relates to a source driver array and driving method, a timing controller and timing control method, and an LCD driving device, and more particularly, to a driving method capable of utilizing a polarity control signal to drive the source driver array and related source driver array, timing controller, timing control method, and LCD driving device.

2. Description of the Prior Art

LCD display devices now have higher resolutions and higher grayscales, and as a result data throughput between a timing controller and source drivers in a panel driving device has greatly increased. This has caused issues such as complex circuitry, higher power dissipation, and more electromagnetic interference (EMI). Accordingly, the industry proposed Reduced Swing Differential Signaling (RSDS) or mini Low-Voltage Differential Signaling (mini-LVDS) interface to address the above-mentioned issues such as circuit complexity and high-frequency transmission.

Please refer to FIG. 1, which is a schematic diagram of an LCD driving device 10 with a conventional mini low-voltage differential signaling interface. The LCD driving device 10 includes a timing controller 102 and a source driver array 104. The source driver array 104 includes a leading source driver SD_L and cascade source drivers SD_1 and SD_2. As shown in FIG. 1, the leading source driver SD_L and the cascade source drivers SD_1 and SD_2 are connected in a cascade manner. Each of the leading source driver SD_L and the cascade source drivers SD_1 and SD_2 includes a start signal input terminal STH_in and a start signal output terminal STH_out. Since the timing controller 102 is connected to the source drivers in a multi-drop architecture, the timing controller 102 simultaneously transmits a same clock signal and frame signal F to each connected source driver. The leading source driver SD_L may receive a start signal STH via its start signal input terminal STH_in, as shown in FIG. 1. The start signal STH received at the start signal input terminal STH_in of the leading source driver SD_L is fixed at a high level. After completing receiving the corresponding frame data from the frame signal F, the leading source driver SD_L outputs the start signal STH via its start signal output terminal STH_out to the start signal input terminal STH_in of the cascade source driver SD_1, to trigger the cascade source driver SD_1 to start receiving the corresponding frame data from the frame signal F. Similarly, after receiving the frame data is complete, the cascade source driver SD_1 outputs the start signal STH to the start signal input terminal STH_in of the cascade source driver SD_2, to trigger the cascade source driver SD_2 to start receiving the corresponding frame data from the frame signal F. In other words, after finishing receiving the corresponding frame data from the frame signal F, each cascade source driver sends the an start signal STH to a next-stage cascade source driver via its start signal output terminal STH_out, to trigger the next-stage cascade source driver to start receiving the frame data. In short, the leading source driver SD_L and the cascade source drivers SD_1 and SD_2 propagate the start signal STH in a cascading manner, to sequentially trigger each source driver to receive the frame data from the frame signal F.

Please refer to FIG. 2, which is a signal timing diagram of the LCD driving device 10 shown in FIG. 1. Sequentially from the top of FIG. 2, the signal waveforms are: differential signals LV1, LV2, LV3, a latch data signal LD, a polarity control signal POL, a start signal STH, and a panel output signal Xout. Note that, the frame signal F includes at least a set of differential signal (here, three sets of differential signals LV1, LV2, and LV3 are shown as an example). The differential signals LV1, LV2, and LV3 are fed to the leading source driver SD_L and the cascade source drivers SD_1 and SD_2 at the same time. Each of the differential signals LV1, LV2, LV3 includes multiple data sections, e.g. data sections DATA1-DATA3. Moreover, at least one of the differential signals (e.g. the differential signal LV1) includes a reset section RST for activating a synchronization procedure when the source drivers are receiving data.

When outputting an image frame, the LCD driving device 10 first transmits a latch data signal LD and a frame signal F via the timing controller 102. After receiving a positive pulse edge of the latch data signal LD and the reset section RST, all of the leading source driver SD_L and the cascade source drivers SD_1 and SD_2 enter a stand-by state. Concurrently, after receiving the reset section RST, the leading source driver SD_L starts receiving the data section DATA1, whereas the cascade source drivers SD_1 and SD_2 are still in the stand-by state without receiving any data. After completing receiving the data section DATA1, the leading source driver SD_L transmits the start signal STH via its start signal output terminal STH_out to the start signal input terminal STH_in of the cascade source driver SD_1, to trigger the cascade source driver SD_1 to start receiving the data section DATA2. Similarly, after receiving the start signal STH transmitted by the cascade source driver SD_1, the cascade source driver SD_2 starts receiving the data section DATA3. In this way, the timing controller 102 can transmit the image data to the leading source driver SD_L and the cascade source drivers SD_1 and SD_2.

However, each source driver is required to transmit the start signal STH to a next-stage source driver, to trigger the next-stage source driver to start receiving data. In such a case, additional circuit connection between the source drivers is required to connect the source drivers together in a cascade, so as to propagate the start signal STH. As a result, extra circuit area and production cost for circuit design would be incurred.

### SUMMARY OF THE INVENTION

Therefore, a primary objective of the invention is to provide a source driver array and driving method, a timing controller and timing controlling method, and an LCD driving device capable of saving circuit area and production cost.

A driving method for a source driver array comprising a leading source driver and at least one cascade source driver is disclosed. The driving method comprises utilizing a latch data signal and a reset section of a frame signal to control the leading source driver and the at least one cascade source driver to enter a stand-by state, respectively, and trigger the leading source driver to receive corresponding data of the frame signal; and utilizing a polarity control signal to sequentially trigger the at least one cascade source driver to receive the corresponding data of the frame signal at different times, and further utilizing the polarity control signal to control signal polarities of multiple source driving signals generated by the leading source driver and the at least one cascade source driver.

A timing control method for a Liquid Crystal Display (LCD) driving device is disclosed. The timing control method comprises generating a frame signal, the frame signal comprising one or more differential signals, each of the differential signal comprising multiple data sections, and at least one of the one or more differential signals comprising at least one reset section; and generating a polarity control signal, wherein during each operation period, the polarity signal has one or more transition edges, each edge positioned before a start point of a corresponding data section of the multiple data sections, respectively.

An LCD driving device is disclosed. The LCD driving device comprises a timing controller, for generating a latch data signal, a polarity control signal, and a frame signal; and a source driver array, the source driver array comprising a leading source driver and at least one cascade source driver; wherein the leading source driver enters a stand-by state and starts receiving corresponding data of the frame signal according to the latch data signal and a reset section of the frame signal, the at least one cascade source driver enters the stand-by state according to the latch data signal and the reset section of the frame signal, respectively, and the at least one cascade source driver sequentially starts to receive the corresponding data of the frame signal at different times according to the polarity control signal, respectively.

A timing controller is disclosed. The timing controller comprises a frame signal generating unit, for generating a frame signal, the frame signal comprising one or more differential signals, each the differential signal comprising multiple data sections, and one of the one or more differential signal comprising at least one reset section; and a system timing control generating unit, for generating a polarity control signal, wherein during each operation period, the polarity signal has one or more transition edges, each edge positioned before an initial point of a corresponding data section of the multiple data sections, respectively.

A source driver array is disclosed. The source driver array comprises a leading source driver; and at least one cascade source driver; wherein the leading source driver enters a stand-by state and starts receiving the corresponding data of the frame signal according to a latch data signal and a reset section of a frame signal, the at least one cascade source driver enters the stand-by state according to the latch data signal and the reset section of the frame signal, respectively, and the at least one cascade source driver sequentially starts receiving the corresponding data of the frame signal at different times, respectively, according to a polarity control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an LCD driving device with a mini low-voltage differential signaling interface according to the prior art.

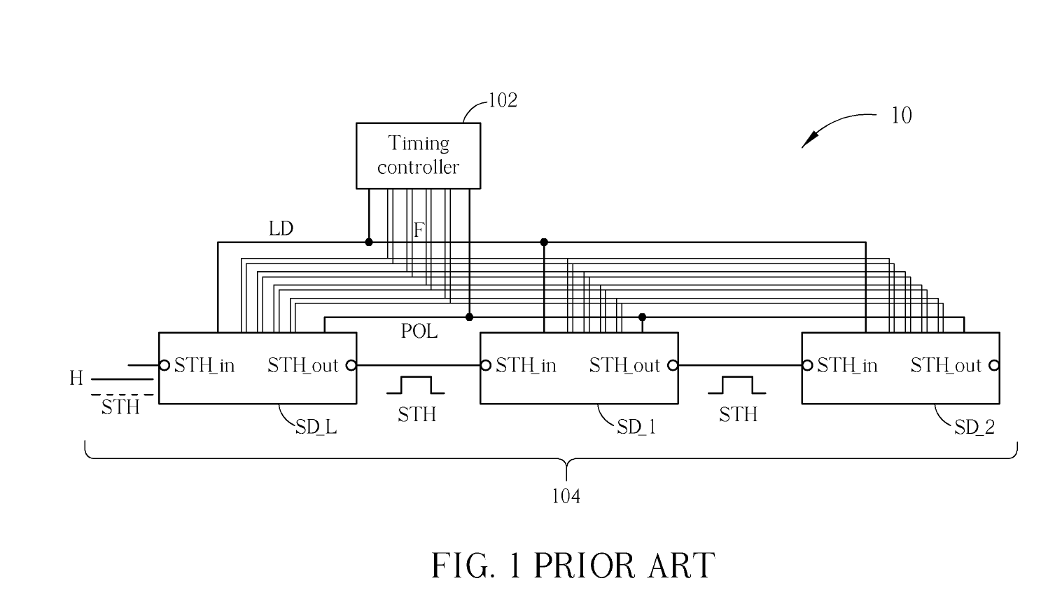

FIG. 2 is a signal timing diagram of the LCD driving device shown in FIG. 1.

FIG. 3 is a schematic diagram of an LCD driving device according to an embodiment.

FIG. 4 is a schematic diagram of a driving process of a source driver array shown in FIG. 3.

FIG. 5 is a signal timing diagram of the LCD driving device shown in FIG. 3.

FIG. 6 is a schematic diagram of an LCD driving device according to another embodiment.

FIG. 7 is a schematic diagram of a table for defining cascading relationship between source drivers according to an embodiment.

### DETAILED DESCRIPTION

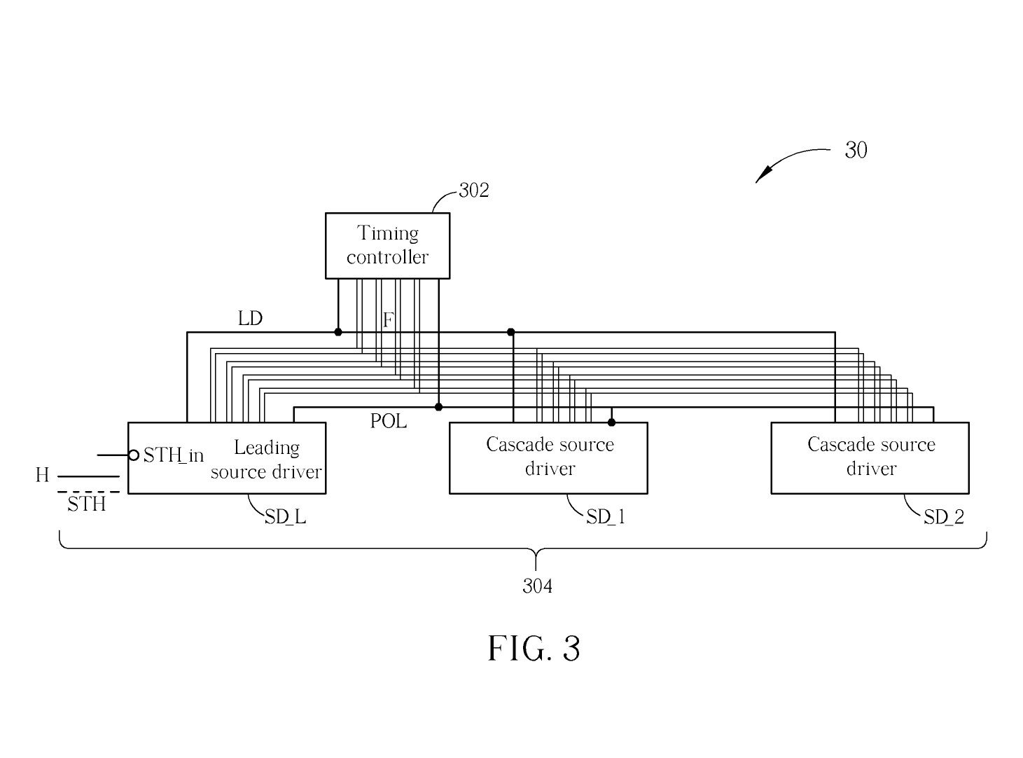

Please refer to FIG. 3, which is a schematic diagram of an LCD driving device 30 according to an embodiment. The LCD driving device 30 includes a timing controller 302 and a source driving array 304. The timing controller 302 includes a system timing control generating unit and a frame signal generating unit (not shown in FIG. 3). The system timing control generating unit generates a latch data signal LD and a polarity control signal POL, wherein the latch data signal LD controls a timing of operations of the source driving array 304. The polarity control signal POL controls trigger timing for each source driver in the source driving array 304 to receive a frame data and signal polarities of source driving signal generated by the source drivers. The frame signal generating unit generates a frame signal F, primarily for providing the frame data. Additionally, the frame signal F is also utilized for trigger the source driving device 304 to receive the frame data. Preferably, the frame signal F includes at least one reset section RST and multiple data sections.

The source driving array 304 includes a leading source driver SD_L and multiple cascade source drivers, e.g. two cascade source drivers SD_1 and SD_2. The leading source driver SD_L and the cascade source drivers SD_1 and SD_2 can output a corresponding source driving signal to a panel (not shown in FIG. 3) according to the received frame data, respectively. Note that, three serially connected cascade source drivers (the leading driver SD_L and the cascade source drivers SD_1 and SD_2 shown in FIG. 3) are used as an illustration, but this is not limited thereto. Any number of cascading source drivers may be used according to system requirements. Moreover, connections between components of the LCD driving device 30 are as shown in FIG. 3, and are not further described herein. A transmission interface between the timing controller 302 and the source driving array 304 is preferably a mini Low-Voltage Differential Signaling (mini-LVDS) interface, to reduce circuit complexity, high-frequency transmission issues, and electromagnetic interference (EMI), but not limited thereto, and may be used for the interface between various timing controllers and source driver arrays, providing that the polarity control signal has a dual functionality of both controlling signal polarities and triggering the cascade source driver in the source driver array.

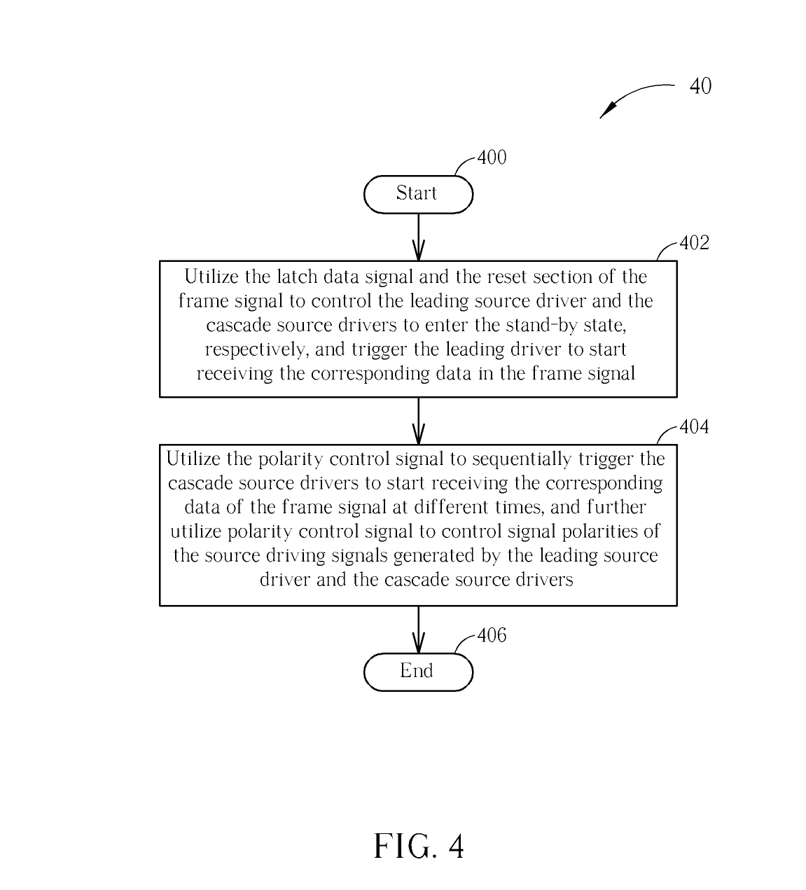

Please refer to FIG. 4 for detailed operations of the LCD driving device 30. FIG. 4 is a schematic diagram of a driving process 40 of the source driver array 304 shown in FIG. 3. Note that, an ordering of steps in the driving process 40 of the source driver array 304 is not limited to that shown in FIG. 4, providing that essentially similar results are achieved. The driving process 40 includes the following steps:

Step 400: Start.

Step 402: Utilize the latch data signal and the reset section of the frame signal to control the leading source driver and the cascade source drivers to enter the stand-by state, respectively, and trigger the leading driver to start receiving the corresponding data in the frame signal.

Step 404: Utilize the polarity control signal to sequentially trigger the cascade source drivers to start receiving the corresponding data of the frame signal at different times, and further utilize polarity control signal to control signal polarities of the source driving signals generated by the leading source driver and the cascade source drivers.

Step 406: End.

According to the driving process 40, in Step 402, the timing controller 302 is utilized to generate the latch data signal LD and the reset section RST of the frame signal F to control the leading source driver SD_L and the cascade source drivers SD_1 and SD_2 to enter a stand-by state, respectively, and trigger the leading driver SD_L to start receiving the corresponding data in the frame signal F. In other words, after receiving the latch data signal LD and the reset section RST of the frame signal F generated by the timing controller 302, the leading source driver SD_L and the cascade source drivers SD_1 and SD_2 enter the stand-by state according to the latch data signal LD and the reset section RST in the frame signal F, respectively. Furthermore, after receiving the latch data signal LD and the reset section RST of the frame signal F, the leading source driver SD_L enters the stand-by state and immediately starts receiving the corresponding data in the frame signal. In other words, the latch data signal LD and the reset section RST of the frame signal F trigger the leading source driver SD_L to receive the corresponding data in the frame signal.

In Step 402, the leading source driver SD_L is triggered and starts receiving the corresponding data in the frame signal, until completion of receiving the corresponding data in the frame signal. Next, in Step 404, the timing controller 302 is utilized to generate the polarity control signal POL, and to sequentially trigger the cascade source drivers SD_1 and SD_2 to receive the corresponding data in the frame signal at different times. As such, the cascade source drivers SD_1 and SD_2 would sequentially start receiving the corresponding data in the frame signal according to the polarity control signal POL generated by the timing controller 302 at different times, respectively. In other words, as shown in FIG. 3, the leading source driver SD_L can also receive a start signal STH having a fixed high level via the start signal input terminal STH_in, without transmitting the start signal STH to a next-stage driver. The cascade source drivers SD_1 and SD_2 in the source driving array 304 would be sequentially triggered according to the polarity control signal POL, so as to receive the corresponding data in the frame signal at different times. Therefore, the leading source driver SD_L and the cascade source drivers SD_1 and SD_2 in the source driver array 304 may extract corresponding frame data from the frame signal at different times.

On the other hand, the polarity control signal POL is also used for controlling the signal polarities of the source driving signals generated by the leading source driver SD_L and the cascade source drivers SD_1 and SD_2. For example, during each operation period of the latch data signal LD, it is possible to utilize an start state of the polarity signal POL to control the signal polarities of the source driving signals generated by the leading source driver SD_L and the cascade source drivers SD_1 and SD_2. In more detail, in the LCD driving device 30, the polarity control signal POL not only serves the functionality of controlling the signal polarities of the source driving signals, but is also responsible for triggering each cascade source driver to receive the corresponding frame data, so as to enable the source drivers to extract the corresponding frame data from the frame signal at different times.

In short, compared to the conventional LCD driving device, the LCD driving device 30 does not require additional circuit connections between the source drivers to transmit the start signal STH, in order to trigger the source drivers to receive the corresponding frame data. The LCD driving device 30 only requires configurations of the timing controller 302, to utilize the existing polarity control signal to sequentially trigger each cascade source driver to receive the corresponding frame data, thereby allowing each source driver to extract the corresponding frame data from the frame signal at different times.

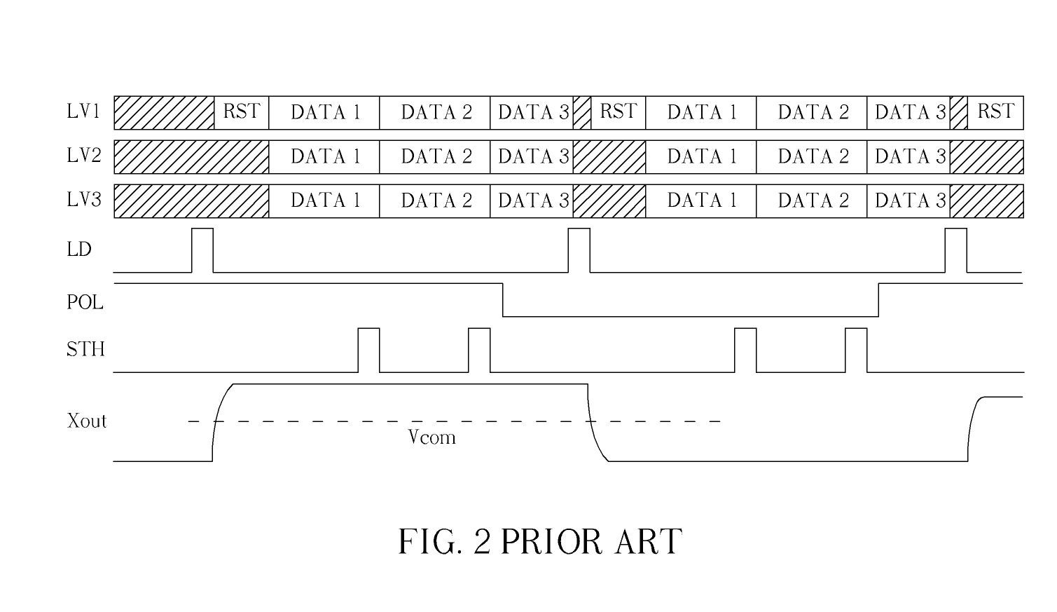

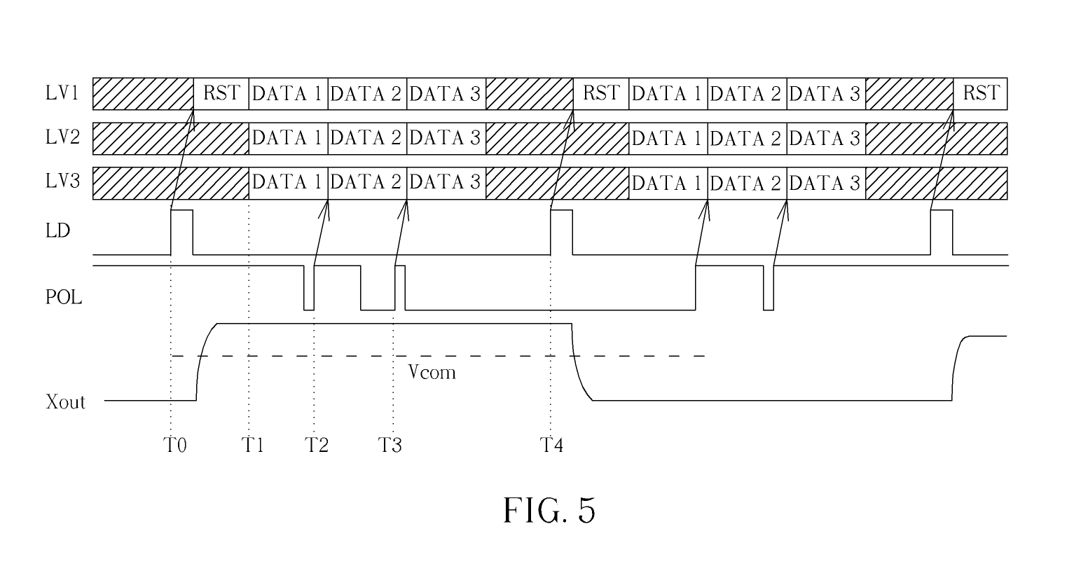

Please refer to FIG. 5, which is a signal timing diagram of the LCD driving device 30 shown in FIG. 3. Sequentially from the top of FIG. 2, the signal waveforms are: the differential signals LV1, LV2, and LV3 (three differential signals are shown here for exemplary purposes, but this is not limited thereto), the latch data signal LD, the polarity control signal POL, and the panel output signal Xout For conciseness, only partial signal waveforms are shown in FIG. 5. Note that, the frame signal F includes the differential signals LV1, LV2, and LV3, which are concurrently fed to the leading source driver SD_L and the cascade source drivers SD_1 and SD_2. Each of the differential signals LV1, LV2, and LV3 includes multiple data sections (e.g. each differential signal including three data sections DATA1-DATA3), corresponding to the frame data for the leading source driver SD_L and the cascade source drivers SD_1 and SD_2, respectively. Moreover, at least one of the differential signals (e.g. the differential signal LV1) includes a reset section RST for triggering the leading source driver SD_L to receive the frame data in each differential signal. As shown in FIG. 5, at a start of each operation period of the latch data signal LD (i.e. an occurrence of a positive pulse edge in the latch data signal LD), a signal level of the polarity control signal POL may be used to indicate the signal polarities of the source driving signals generated by the leading source driver SD_L and the cascade source drivers SD_1 and SD_2. For example, at time points T0 and T4, the signal level of the polarity control signal POL is at a high voltage level and a low voltage level, respectively. Therefore, as shown in FIG. 5, signal polarities of the panel output signal Xout (the source driving signal generated by the source driver) also correspond to the signal polarities of the polarity control signal at time points T0 and T4, respectively.

Furthermore, during each operation period of the latch data signal LD (a period between two consecutive pulses of the latch data signal LD), after receiving a positive pulse edge in the latch data signal LD and the reset section RST of the frame signal F, the leading source driver SD_L and the cascade source drivers SD_1 and SD_2 would enter the stand-by state according to the latch data signal LD, respectively. At the same time, the leading source driver SD_L also starts receiving the corresponding frame data in the frame signal F, (i.e. start receiving data from the data section DATA1 of each differential signal). In other words, as shown in FIG. 5, at a time point T1, the reset section RST of the frame signal F triggers the leading source driver SD_L to receive the corresponding frame data. Note that, the timing diagram shown in FIG. 5 is only a preferred example, and other variations are also possible. For example, it is possible to utilize a start signal maintained at a fixed voltage level to control the leading source driver SD_L to directly start receiving the corresponding data in the frame signal F after entering the stand-by state.

On the other hand, please continue to refer to FIG. 5. During each operation period of the latch data signal LD, the polarity control signal POL further includes two transition edges, corresponding to trigger times of the cascade source drivers SD _1 and SD_2, respectively. Namely, during each operation period of the latch data signal LD, a total number of transition edges in the polarity control signal POL may equal a total number of the cascade source drivers. For example, at time points T2 and T3, respectively, there is a low-to-high transition edge in the polarity control signal POL to trigger the corresponding cascade source driver. Therefore, it is possible to utilize the polarity control signal POL to trigger the cascade source drivers SD_1 and SD_2 to start receiving the corresponding data section before initial points of the corresponding data sections, respectively.

In more detail, each cascade source driver may count a number of occurrences of transition edges in the polarity control signal POL to discern when to start receiving the corresponding data section. For example, the cascade source driver SD_1 would start receiving the data section DATA2 in each differential signal after detecting a first low-to-high transition edge in the polarity control signal POL (time point T2). The cascade source driver SD_2 would start receiving the data section DATA3 in each differential signal after detecting a second low-to-high transition edge in the polarity control signal POL (time point T3).

In more detail, the leading source driver SD_L and the cascade source drivers have different trigger conditions. The leading source driver SD_L starts receiving data from the data section DATA1 in each differential signal after receiving a positive pulse edge in the latch data signal LD and the reset section RST of the frame signal F (i.e. time point T1). The cascade source driver SD_1 enters the stand-by state after receiving a positive pulse edge in the latch data signal LD and the reset section RST of the frame signal F, and starts receiving data from the data section DATA2 in each differential signal after receiving a first low-to-high transition edge in the polarity control signal POL (e.g. time point T2). The cascade source driver SD_2 enters stand-by state after receiving a positive pulse edge in the latch data signal LD and the reset section RST of the frame signal F, and starts receiving data from the data section DATA3 in each differential signal after receiving a second low-to-high transition edge in the polarity control signal POL (e.g. time point T3). Therefore, as shown in FIG. 5, the leading source driver SD_L and the cascade source drivers SD_1 and SD_2 would receive the corresponding frame data at different times.

Please continue to refer to FIG. 5. During each operation period of the latch data signal LD, the timing controller 302 utilizes a number of occurrences of low-to-high transition edges in the polarity control signal POL to sequentially trigger the cascade source drivers SD_1 and SD_2 to receive the corresponding frame data in the frame signal F. To this end, it is possible to utilize other types of signals or signal combinations in conjunction with the polarity control signal POL, so as to ensure each cascade source driver receives the correct number of transition edges in the polarity control signal POL, so as to be triggered to sequentially receive the corresponding frame data in the frame signal F.

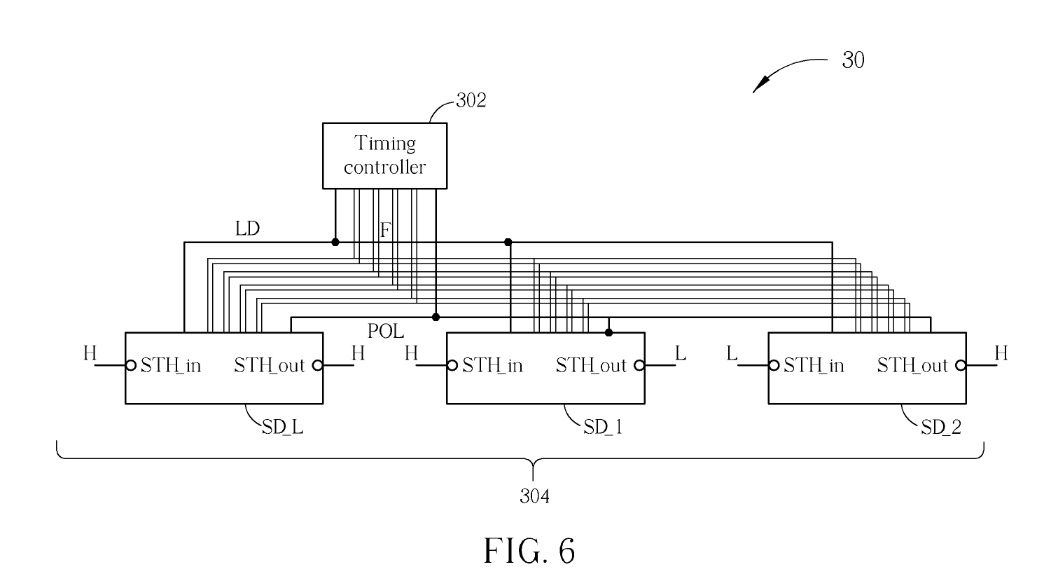

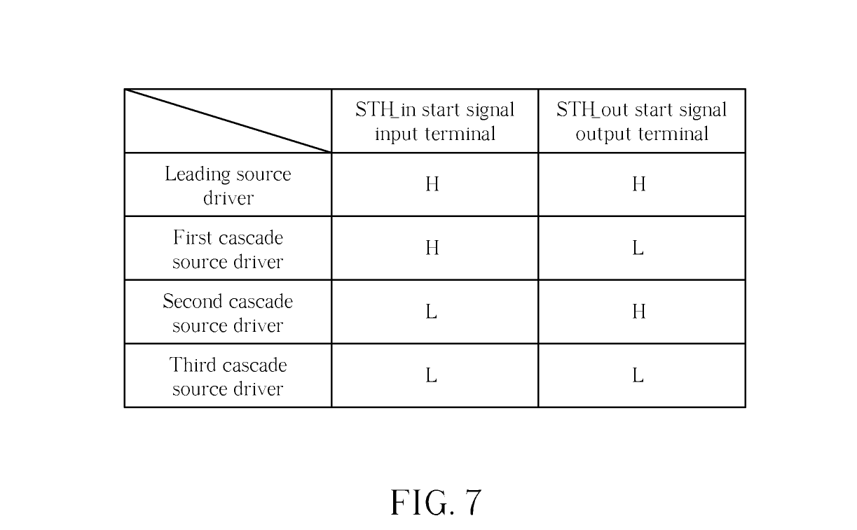

For example, please refer to FIGS. 6 and 7. As shown in FIG. 6, the leading source driver SD_L and the cascade source drivers SD_1 and SD_2 both have a start signal input terminal STH_in and a start signal output terminal STH_out. It is therefore possible to utilize different voltage level combinations of the start signal input terminal STH_in and the start signal output terminal STH_out to define a sequence with which each source driver is triggered. In other words, it is possible to assign the start signal input terminal and the start signal output terminal of each source driver with corresponding voltage signals according to the predefined combination to indicate when each source driver should be triggered to start receiving the corresponding frame data in the frame signal F. In such a case, it is possible to determine a particular pulse or transition edge within the polarity control signal on which each of the source drivers should be triggered, according to a voltage level combination received at the start signal input terminal and the start signal output terminal.

For example, please refer to FIG. 7, wherein H represents a high voltage level, and L represents a low voltage level. When the voltage levels of the start signal input terminal STH_in and the corresponding start signal output terminal STH_out form a combination “HH”, it represents that the source driver is a leading source driver; likewise, a voltage level combination “HL” denotes that the source driver is a first cascade source driver; voltage level combination “LH” denotes that the source driver is a second cascade source driver; whereas voltage level combination “LL” denotes that the source driver is a third cascade source driver. Therefore, referring back to FIG. 6, since a voltage level combination of the start signal input terminal STH_in and the start signal output terminal STH_out of the leading source driver SD_L is “HH”, the leading source driver SD_L would start receiving data from the data section DATA1 of each differential signal after receiving a positive pulse edge of the latch data signal LD and the reset section RST of the frame signal F (e.g. time point T1 shown in FIG. 5). Furthermore, the voltage level combination of the start signal input terminal STH_in and the start signal output terminal STH_out of the cascade source driver SD_1 is “HL”; thus, the cascade source driver SD_1 would start receiving data from the data section DATA2 of each differential signal after receiving a first low-to-high transition edge of the polarity control signal POL (e.g. time point T2 shown in FIG. 5). Similarly, the cascade source driver SD_2 would start receiving data from the data section DATA3 of each differential signal after receiving a second low-to-high transition edge in the polarity control signal POL (e.g. time point T3 shown in FIG. 5).

In summary, the polarity control signal POL generated by the timing controller 302 can not only controls signal polarities of the source driving signals generated by the source drivers, but also acts to trigger the timing at which the cascade source drivers receive the corresponding frame data. Compared with the conventional LCD driving device, the LCD driving device 30 does not require additional circuit connections between the source driver to transmit the start signal STH, and it is possible for the timing controller 302 to simply utilize the existing polarity control signal to trigger each cascade source driver to receive the corresponding frame data, for each source driver to extract corresponding frame data from the frame signal at different times. Therefore, circuit area and production costs can be effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for a source driver array, the source driver array comprising a leading source driver and at least one cascade source driver, the driving method comprising:
utilizing a latch data signal and a reset section of a frame signal to control the leading source driver and the at least one cascade source driver to enter a stand-by state, respectively, and trigger the leading source driver to start receiving corresponding data of the frame signal; and
utilizing a polarity control signal to sequentially trigger the at least one cascade source driver to start receiving the corresponding data of the frame signal at different times, and further utilizing the polarity control signal to control signal polarities of multiple source driving signals generated by the leading source driver and the at least one cascade source driver.

2. The driving method of claim 1, wherein during each operation period of the latch data signal, an initial state of the polarity signal is used for controlling the signal polarities of the multiple source driving signals generated by the leading source driver and the at least one cascade source driver.

3. The driving method of claim 1, wherein during each operation period of the latch data signal, the polarity control signal has one or more transition edges, corresponding to times at which the at least one cascade source driver is triggered, respectively.

4. The driving method of claim 1, wherein the frame signal comprises one or more differential signals, each of the differential signal comprising multiple data sections, comprising the corresponding data of the at least one cascade source driver, respectively, and each of the one or more transition edges of the polarity control signal is before an initial point of a corresponding data section of the multiple data sections, respectively.

5. The driving method of claim 1, further comprising utilizing a start signal maintained at a fixed voltage level to control the leading source driver to directly start receiving the corresponding data of the frame signal after entering the stand-by state.

6. The driving method of claim 1, further comprising setting voltage levels of a start signal input terminal and an start signal output terminal of each of the leading source driver and the at least one cascade source driver, respectively, to utilize different combinations of the voltage levels to decide which pulse within the polarity control signal by which the leading source driver and the at least one cascade source driver are triggered, respectively.

7. A timing control method for a Liquid Crystal Display (LCD) driving device, the method comprising:
generating a frame signal, the frame signal comprising one or more differential signals, each of the differential signal comprising multiple data sections, and at least one of the one or more differential signals comprising at least one reset section; and
generating a polarity control signal, wherein during each operation period, the polarity signal has one or more transition edges, each edge positioned before an initial point of a corresponding data section of the multiple data sections, respectively.

8. A Liquid Crystal Display (LCD) driving device, comprising:
a timing controller, for generating a latch data signal, a polarity control signal, and a frame signal; and
a source driver array, the source driver array comprising a leading source driver and at least one cascade source driver;
wherein the leading source driver enters a stand-by state and starts receiving corresponding data of the frame signal according to the latch data signal and a reset section of the frame signal, the at least one cascade source driver enters the stand-by state according to the latch data signal and the reset section of the frame signal, respectively, and the at least one cascade source driver sequentially starts to receive the corresponding data of the frame signal at different times according to the polarity control signal, respectively.

9. The LCD driving device of claim 8, wherein the leading source driver and the at least one cascade source driver decides signal polarities of multiple source driving signals according to the polarity control signal.

10. The LCD driving device of claim 9, wherein the leading source driver and the at least one cascade source driver decide the signal polarities of the source driving signals according to an initial state of the polarity control signal during each operation period of the latch data signal.

11. The LCD driving device of claim 8, wherein the leading source driver starts receiving the corresponding data of the frame signal after receiving the reset section of the frame signal during each operation period of the latch data signal.

12. The LCD driving device of claim 8, wherein the polarity control signal has one or more transition edges corresponding to times at which the at least one cascade source driver starts receiving the corresponding data of the frame signal, respectively, during each operation period of the latch data signal.

13. The LCD driving device of claim 8, wherein the frame signal comprises one or more differential signals, each the differential signal comprising multiple data sections, respectively comprising the corresponding data of the at least one cascade source driver, and each of the one or more transition edges of the polarity control signal is before an initial point of a corresponding data section of the multiple data sections, respectively.

14. The LCD driving device of claim 8, wherein the leading source driver directly starts receiving the corresponding data of the frame signal after entering the stand-by state according to a start signal maintained at a fixed voltage level.

15. The LCD driving device of claim 8, wherein each of the leading source driver and the at least one cascade source driver has a start signal input terminal and a start signal output terminal, for receiving different voltage level configurations to control which pulse within the polarity control signal by which to be triggered.

16. A timing controller, comprising:
a frame signal generating unit, for generating a frame signal, the frame signal comprising one or more differential signals, each the differential signal comprising multiple data sections, and one of the one or more differential signal comprising at least one reset section; and
a system timing control generating unit, for generating a polarity control signal, wherein during each operation period, the polarity signal has one or more transition edges, each edge positioned before an initial point of a corresponding data section of the multiple data sections, respectively.

17. A source driver array, comprising:
a leading source driver; and
at least one cascade source driver;
wherein the leading source driver enters a stand-by state and starts receiving the corresponding data of a frame signal according to a latch data signal and a reset section of the frame signal, the at least one cascade source driver enters the stand-by state according to the latch data signal and the reset section of the frame signal, respectively, and the at least one cascade source driver sequentially starts receiving the corresponding data of the frame signal at different times, respectively, according to a polarity control signal.

18. The source driver array of claim 17, wherein the leading source driver and the at least one cascade source driver further decides signal polarities of source driving signals to be generated according to a state of the polarity control signal during each operation period of the latch data signal.
